(19) United States
(12) Patent Application Publication
(10) Pub. No.: US 2005/0219670 A1
(43) Pub. Date: Oct. 6, 2005

(54) Holographic data storage system

(76) Inventors: Patrick Meyrueis, Strasbourg (FR); Idriss El Hafidi, Strasbourg (FR); Romualda Grzymala, Strasbourg (FR); Joel Fontaine, Strasbourg (FR)

Correspondence Address: DISCOVISION ASSOCIATES;INTELLECTUAL PROPERTY DEVELOPMENT, 2355 MAIN STREET, SUITE 200, IRVINE, CA, 92614, US

(21) Appl. No.: 10/512,659

(22) PCT Filed: Apr. 26, 2002
(86) PCT No.: PCT/EP02/05454

§ 371 Date: Oct. 25, 2004

(51) Int. Cl. G03H 1/04

(52) U.S. Cl. 359/35; 359/30

(57) ABSTRACT

Apparatus is disclosed that comprises a holographic memory device in which a plurality of data packets are stored as diffractive patterns, a beam system adapted to transmit a reference beam to the memory device to read the packets sequentially, a microlens array, a solid state scanning system (e.g a microoptoelectromechanical device) and a photodetector array in which the microlens array is adapted to focus the output beam corresponding to each data packet on the same spatial area in the central part of a solid state scanning system and the solid state scanning system then routes it to a photodetector array. This allows the use of a fast solid state scanning system, which has a limited angular scanning range, without losing data at the edge of the matrix of points in which the data packet is recorded.

### FIELD OF THE INVENTION

The present invention generally relates to photonics data memory devices. In particular, the present invention relates to a microlens used in reading data memory devices.

### BACKGROUND OF THE INVENTION

There is a strong interest in high-capacity data storage systems with fast data access due to an ever-increasing demand for data storage. Limitations in the storage density of conventional magnetic memory devices have led to considerable research in the field of optical memories. Holographic memories have been proposed to supersede the optical disc (compact disc read only memories, or CD-ROMs, and digital video data, or DVDs) as a high-capacity digital storage medium. The high density and speed of holographic memory results from the use of three-dimensional recording and from the ability to simultaneously read out an entire page of data. The principal advantages of holographic memory are a higher information density, a short random-access time, and a high information transmission rate.

In holographic recording, a light beam from a coherent monochromatic source (e.g., a laser) is split into a reference beam and an object beam. The object beam is passed through a spatial light modulator (SLM) and then into a storage medium. The SLM forms a matrix of cells that modulate light intensity with grey levels. The SLM forms a matrix of shutters that represents a page of binary or grey-level data. The object beam passes through the SLM, which acts to modulate the object beam with binary information being displayed on the SLM. The modulated object beam is directed to one point, after an appropriate beam processing, where it intersects with the reference beam after being routed by an addressing mechanism. It is also contemplated that for multispectral holography, the multispectral hologram may be recorded with more than one wavelength from different lasers or from the same multiline laser at the same time. In other words, the recording can be operating with several wavelengths in the holographic multiplexing process.

An optical system consisting of lenses and mirrors is used to precisely direct the optical beam encoded with the packet of data to the particular addressed area of the storage medium. Optimum use of the capacity of a thick storage medium is realized by spatial and angular multiplexing that can be enhanced by adding frequency polarization, phase multiplexing, etc. In spatial multiplexing, a set of packets is stored in the storage medium and shaped into a plane as an array of spatially separated and regularly arranged subholograms by varying the beam direction in the X-axis and Y-axis of the plane. Each subhologram is formed at a point in the storage medium with the rectangular coordinates representing the respective packet address as recorded in the storage medium. In angular multiplexing, recording is carried out by keeping the X- and Y-coordinates the same while changing the irradiation angle of the reference beam in the storage medium. By repeatedly incrementing the irradiation angle, a plurality of packets of information is recorded as a set of subholograms at the same X- and Y-spatial location.

A volume (thick) hologram requires a thick storage medium, made up of a material sensitive to a spatial distribution of light energy produced by interference of a coherent object light beam and a reference coherent light beam. A hologram may be recorded in a medium as a variation of absorption or phase or both. The storage material responds to incident light patterns causing a change in its optical properties. In a volume hologram, a large number of packets of data can be superimposed, so that every packet of data can be reconstructed without distortion. A volume (thick) hologram may be regarded as a superposition of three-dimensional gratings recorded in the depth of the recording photosensitive material, each satisfying the Bragg law (i.e., a volume phase grating). The grating planes in a volume hologram produce changes in refraction and/or absorption.

While holographic storage systems have not yet replaced current compact disc (CD) and digital video data (DVD) systems, many advances continue to be made which further increase the potential of storage capacity of holographic memories. This includes the use of various multiplexing techniques such as angle, wavelength, phase-code, fractal, peristrophic, and shift. However, methods for recording information in highly multiplexed volume holographic elements, and for reading them out, have not proved satisfactory in terms of throughput, crosstalk, and capacity.

Currently, to read data from a point in a holographic memory device, a scanning addressing method is used. This allows access to one packet of data recorded on an array of points. Using this method, geometrical limitation is induced, since the edge of the point matrix (i.e., the external points of the matrix) may not be sensed by a sensing device. This limitation comes from the fact that in a fast solid state scanning system that has a limited angular scanning range together with the size of the sensing the device, some of the data at the points at the edge of the matrix may be lost, since the sensing device may not be able to sense them. In other words, each point in the memory device/recording plate defines a central part and a peripheric surrounding. Unlike the central part, where data packets can be sensed by a sensing device, the sensing device is unable to sense some of the information in the data packets in the peripheric surrounding because of the optical aberration and the limited field of the objective of the sensing device. A reading system is developed to be able to read the points at the edge of an even bigger matrix.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIGS. 1A and 1B are schematic representations of an apparatus for recording an interference pattern in accordance with one embodiment of the invention.

FIG. 2 is a schematic representation of an apparatus for reading the interference pattern using a microlens in accordance with one embodiment of the invention.

FIG. 3 is a schematic representation of an array of microlenses used in a reading apparatus in accordance with one embodiment of the invention.

### DETAILED DESCRIPTION OF THE INVENTION

The present invention is a reading system that comprises a solid state dynamic diffractive optical element device for reading information from a diffractive optics memory. The diffractive optics memory has information stored therein, located at a plurality of points on the memory and at a plurality of angles at each one of the points so as to form a plurality of packets of information at each of the points. The diffractive optics memory is arranged in the form of a matrix, or alternately, may be arranged in other forms, such as a tape or a disk. The matrix of the dynamic diffractive elements device is a routing device and is configured to shape and angularly direct a wavefront of a coherent light beam to the memory at one of the angles of one of the points to reconstruct one of the packets of information. In one embodiment, the dynamic routing is based on the use of dynamic grating. The dynamic grating is a diffractive structure that is engineered to change the diffractive effect by changing the dynamically in a controlled way. The way the grating is produced controls the duration of the output diffracted beam. The present invention introduces the use of a microlens arranged in a microlens matrix for reading holographic memory. The microlens is positioned on the output beam path to focus the output beam to an addressing device. The microlens is located close to a point of a matrix of the holographic memory to achieve the local storage capacity while optimizing the focusing of all of the data packets on the addressing device. The addressing device is used to address or route these packets of data embedded in the output beam toward a sensing device through an imaging lens. By this means, all of the extended recording points can provide data packets that can be read by the sensing device, since these packets of data (images) are in the sensing field of the sensing device (e.g., charge-coupled device (CCD) camera).

Further advantages and novel features of the present invention will become apparent to those skilled in the art from this disclosure, including the following detailed description, as well as by practice of the invention. While the invention is described below with reference to illustrative embodiments, this description is not intended to be construed in a limiting sense. Those of ordinary skill in the art having access to the teachings herein will recognize additional implementations, modifications, and embodiments, as well as other fields of use, which are within the scope of the invention as disclosed and claimed herein, and with respect to which the invention could be of significant utility.

Storing/Recording Phase

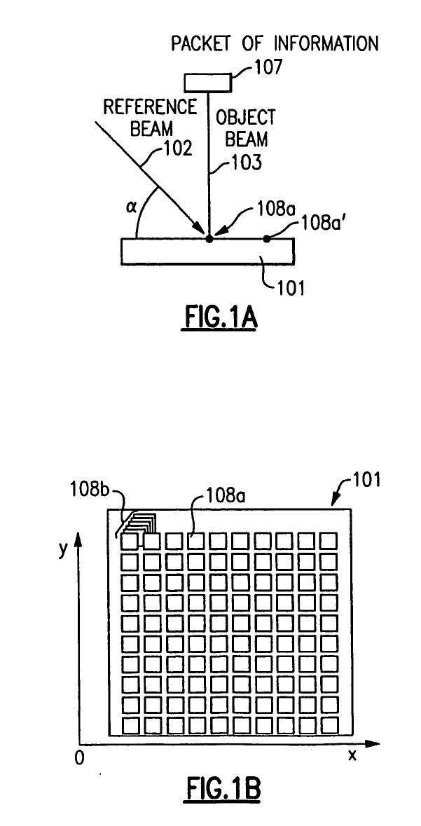

FIG. 1A is a schematic representation of an apparatus for recording an interference pattern in accordance with one embodiment of the invention. In a recording phase, a laser provides a laser beam (i.e., coherent light beam) to the beam splitter system. The laser may be a YAG doubled laser (i.e., a solid state laser) where a rod of YAG material emits laser light in the infrared to the laser. The laser beam emanating from laser is split into a reference beam 102 and an object beam 103. The reference laser beam 102 interferes coherently with the object beam 103 to form the interference patterns or holograms 107, which are stored in the recording medium due to the perturbation in the refractive index. Thus, each hologram is stored at a unique angle of the reference beam α. The separation between the various holograms stored within the same volume relies on the coherent nature of the hologram in order to allow its retrieval in phase with the volume only for a defined angle value. In one embodiment, a nonlinear crystal (i.e., KDP) is used to double the frequency of a laser. For instance, the YAG is naturally emitting in the infrared by using a KDP in the YAG laser beam output. The KDP transforms the infrared light from the YAG laser into a green light. In other words, the emitted frequency is effectively doubled. This process allows the laser to provide a green light out of an infrared laser light. This doubled frequency is also coherent and the resulting wavelength fits the sensitivity of the recording material.

The memory device 101 has a plurality of cells to hold the recorded information. The memory device 101 is a holographic memory device that contains information stored during a phase of storing information. The memory device 101 is typically a three-dimensional body made up of a material sensitive to a spatial distribution of light energy produced by interference of the object beam 103 and the reference light beam 102. A hologram (e.g., pattern 107) may be recorded in the medium 101 as a variation of absorption or phase or both. The storage material responds to incident light pattern modulations, causing the change in its optical properties. In a volume (thick) hologram, a large number of packets of data can be superimposed, so that every packet of data can be reconstructed without distortion. The volume hologram may be regarded as a superposition of three-dimensional gratings recorded in the depth of the layer of the recording material, each satisfying the Bragg law (i.e., a volume phase grating). The grating structures in a volume hologram produce change in refraction and/or absorption. The memory device 101 may be arranged in the form of a flat layer, herein referred to as a matrix (see FIG. 1B). Each of a plurality of points on the matrix is defined by its rectilinear coordinates (X,Y). An image-forming system (not shown) reduces the object beam 103 to the sub-hologram 108a having a minimum size at one of the X,Y point of the matrix. A point in physical space, defined by its rectilinear coordinates, contains a plurality of packets 108b.

In one embodiment, the memory device 101 is constructed of organic material, such as a polypeptide material, and made in accordance with the techniques described in the co-pending patent application entitled “Photonics Data Storage System Using a Polypeptide Material and Method for Making Same,” Serial No. PCT/FR01/02386, which is herein incorporated by reference.

A display may be any device for displaying data packets in a system, such as spatial light modulators (SLMs) or liquid crystal light valves (LCLVs). The plurality of bits represented on the display screen of the display is presented as a two-dimensional pattern of transparent and opaque pixels (i.e., data packet). The data packet displayed is derived from any source such as a computer program, the Internet, and so forth. In an Internet storage application, the packets displayed may be formatted similarly to the packets of the Internet.

The object beam 103 after passing through the display, acts to modulate the object beam 103 with the binary information. The object beam 103 is then directed to a defined point on the recording medium 101 where it intersects with the reference beam 102 to create a plurality of interference patterns loaded with data packets. A lens (not shown) may be used to converge the modulated object beam 103 and to focus the beam to the recording medium 101. In other words, the modulated beam 103 becomes reduced by means of a suitable lens so that the point of convergence of the modulated object beam lies slightly beyond the recording medium 101. The reference beam 102 and the object beam are positioned at different angles by the angular multiplexing method so that a plurality of data packets is recorded at one point of the recording medium 101.

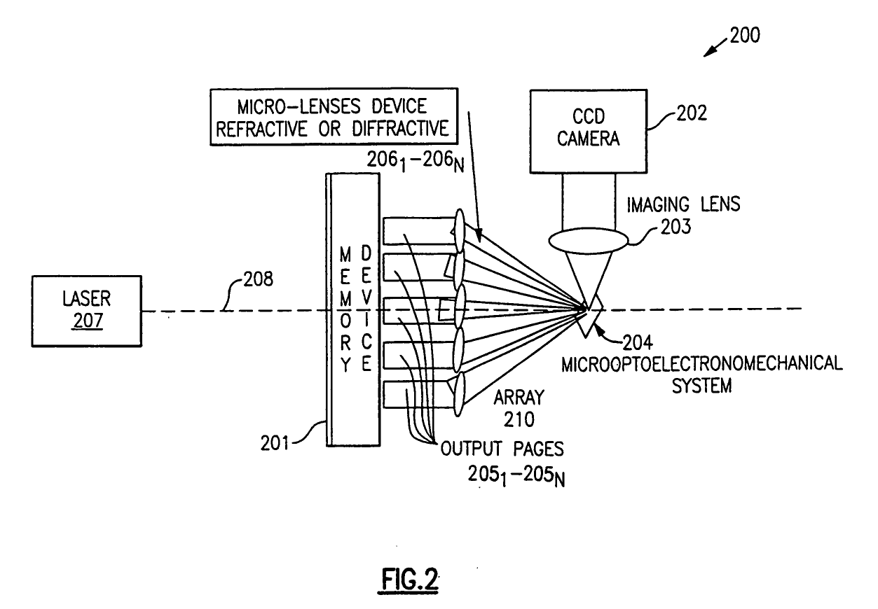

As stated above, the recording system, as shown in FIG. 1A, includes the single reference beam 102, the object beam 103, and the recording medium 101. The reference beam 102 and the object beam 103 intersect to form patterns to be recorded on the recording medium 101 at an X,Y location. The reference beam 102 is angularly multiplexed so that different data can be recorded on one point (e.g., point 108a) of the recording medium 101. The reference beam 102 is also spatially multiplexed so that data can be recorded on different points of the recording medium 101 (see FIG. 2). This is the spatial multiplexing that is carried out by sequentially changing the rectilinear coordinates. Angular multiplexing is achieved by varying the angle α of the reference beam 102 with respect to the surface plane of the storage medium 106. The separate packet of information 107 is recorded in the storage medium 101 as a diffraction pattern (e.g., a sub-hologram) for each selected angle α and spatial location. Spatial multiplexing is achieved by shifting the reference beam 102 with respect to the surface of the storage medium 101 so that a point (e.g., point 108a) shifts to another spatial location, for example, point 108a′, on the surface of the storage medium 101. The spatial multiplexing is carried out by sequentially changing the rectilinear coordinates. Angular multiplexing is carried out by sequentially changing the angle of the reference beam 102 by means of mirrors (not shown). A data packet is reconstructed by shining the reference beam 102 at the same angle and spatial location at which the data packet was recorded. The portion of the reference beam 102 diffracted by the storage medium material forms the reconstruction, which is typically detected by a detector array. The storage medium 101 may be mechanically shifted in order to store data packets at different points by its coordinates (X,Y).

The storage medium 101 is arranged in a matrix. Each of a plurality of points on the matrix is defined by its rectilinear coordinates signals involved in recording a diffraction pattern (i.e., a hologram) in a storage medium using angular and spatial multiplexing. Various diffractive recording processes have been developed in the art, and further details can be found in the book Holographic Data Storage by H. J. Coufal, D. Psaltis, and G. T. Sincerbox (Springer 2000). It is contemplated that a storage diffractive pattern, in some cases, can also be implemented by using techniques other than the interference of a reference and object beam, such as using an e-beam and a microlithography process for etching materials to generate diffractive structures.

Reading Phase

FIG. 2 shows a schematic representation of a reading and addressing system according to one embodiment of the present invention. The reading and addressing system 200 includes the memory device 201, refractive or diffractive microlenses array 210, an addressing device (e.g., microoptoelectronomechanical system, or MEOMS) 204, an imaging lens 203, a sensing device (e.g., CCD camera) 202 and a laser 207. The sensing device 204 may be a solid-state chip produced by microlithography and includes micromechanical electronics and photonics.

The microlenses array 210 includes a plurality of microlenses 206₁ to 206_{N} that are positioned or located in front of each corresponding point in the point matrix on the recording medium 201. The corresponding recorded points are in the paths between the memory device 201 and the addressing device 204 (i.e., each point is dedicated to its corresponding microlens arranged in the microlens array 210). Each microlens from the microlens array 210 is calculated and realized to focus its corresponding output beams carrying the output pages 205₁ to 205_{N}. The output beams (i.e., output pages) are focused on the same spatial area on the addressing device 204 as shown in FIG. 2. The positioning of the microlenses 206₁ to 206_{N} is calculated through a computer-aided design/computer-aided manufacturing (CAD/CAM). The microlenses 206₁ to 206_{N} provide a wider range of field sensing and aberrations without increasing the angle of the sensing device 202. The microlenses 206₁ to 206_{N} are used to focus the output beams to the addressing device 204. The microlenses at the output pages provide a better reading of data located at the edge of the information points. This extends the storage surface, and therefore increases the storage capacity. The increase of capacity in the storage device (i.e., memory device 201) is due to the fact that there is more surface area available for storage by using the edge area for storing information.

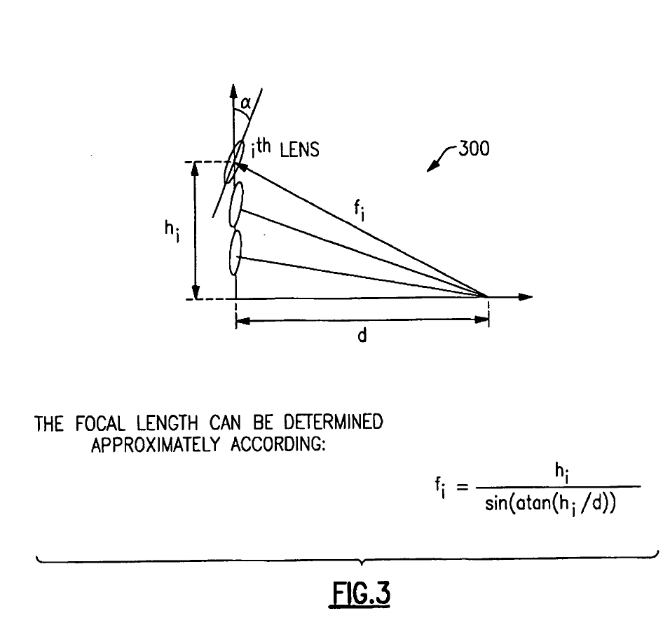

Referring to FIG. 3, there is shown a schematic representation of an array of “i” microlenses and their related focal lengths according to one embodiment of the invention. The calculation of the focal lenses depends on the localization of these lenses in the microlens array 210. The focal length fᵢ (i.e., the distance between the microlens i^{th} to the point on the addressing device 204), is calculated according to the following formula:

$${f}_{i} = \frac{{h}_{i}}{sin ( atan ( {h}_{i} / d )}$$

where hᵢ is the Y-axis (i.e., vertical) distance between the center point of the i^{th} lens and the point on the addressing device 204; and

d is the X-axis (i.e., horizontal) distance between the cent FIG.er point of the i^{th} lens and the point on the addressing device 204.

α is the angle in which the i^{th} lens is positioned with respect to the X-Y axis. The determining of the angle α for every lens reference is the “i” number (i.e., the order of the microlens in the matrix of microlenses). The angle α is determined by using optical CAD/CAM software. In other words, a is the tilt value between the i^{th} lens plane and vertical axis is calculated using the CAD/CAM. The CAD/CAM software provides calculation in such a way that all the microlenses in the array focus on the same points located in the central part of the addressing system 204 (e.g., MEOMS). In one embodiment, the diameter of the microlens is 1 mm and the lens centers are spaced by 1 mm. Referring back to FIG. 2 where the microlenses 206₁ to 206_{N} focus on one point of the addressing device 204 (i.e., the focusing point is common to all the lenses in the microlens array). This point is located on the addressing device 204 for routing the beam to the sensing device 202. Each lens has a different focus depending on its location on the array plane. The calculation of each lens depends on its corresponding recording point on the memory device 201. The value of the focusing point changes and is then calculated through an optical CAD/CAM. The positions of the microlenses are calculated to address every packet of the memory device 201. The diameter of each lens matches or corresponds to the size of its recording point. The size of the lenses corresponds to the size of the beam and the divergence of the output beam. The size of lenses also depends on the wavelength used for reading. The addressing device 204 allows the synchronized reading of the entire extended matrix at high speed, operating packet by packet and using the sensing device 202. Since there is no need to electronically correct eventual disalignment due to errors in electro opto mechanical adjustment, the reading is fast. Furthermore, with appropriate programming the addressing device 204 compensates the geometrical noise, and the sensing device 202 can sense all the data in the targeted area.

The addressing device 204 may be composed of electronics, mechanics, optics or other elements. In one embodiment, the addressing device 204 is a MEOMS and is engineered and programmed to address the beam moving from one point to the sensing device 202. The MEOMS 204 is the integration and combination of optics with electronics and mechanics. Various types of MEOMS have been developed in the art and further details can be found in the book entitled Digital Diffractive Optics: An Introduction to Planar Diffractive Optics and Related Technology, by B. Kress and P. Meyrueis (Wiley and Sons, 2000). In one embodiment, the MEOMS 204 is designed to allow a synchronized reading of the entire extended matrix in the memory device 201 at a high speed. The MEOMS 204 addresses the matrix of points on the memory 201 in which data is recorded by spatial and angular multiplexing. Since only one sensing device 202 is used, the reading is sequential, i.e., packet by packet. All the outputs of the microlenses are focused on the addressing device 204. The addressing device 204 then routes the beam to the sensing device 202. The routing depends on the voltage applied to the addressing device 204 to obtain the right deflection. The output beam from each microlens depends on its location in the microlens array. A specific voltage is calculated, optimized and stored into a memory (e.g., computer memory) for each location of the microlens. The voltage applied to the frame of the appropriate sequence depends on the operational microlens. This sequence is synchronized with the sensing device 202. For simple programming of the addressing device 204, all beams are located in one plane.

The imaging lens 203 focuses the beam from the point on the addressing device 204 to the sensing device 202. To optically optimize, the sensing device 202 is located on the same focal plane of the imaging lens 203. This reduces noise, and therefore provides quality data. One way in which the optical optimization occurs is in the utilization of the function transfer modulation (FTM) method, which is used for optically optimizing the sensed beam by the sensing device 202. Another way is through the use of an optical CAD/CAM. The optical CAD/CAM defines the characteristics of the lens (e.g., focus, diameter of the lens, material focus, etc). The geometrical positioning of the lens in the system depends on the size of the output image. The CAD/CAM also provides the positioning and the size of the addressing device 204 to be used in the reading system. This provides accuracy in which data is specified with a tolerance level that fits the recording tolerance of the material used in the recording plate 201.

The sensing device 202 may be any sensor that can sense the images from the output of the addressing system 203. The sensing device 202 may be made of CCD or CMOS (complementary metal-oxide-semiconductor) active pixel sensors (APS). In one embodiment, the sensing device 202 is a charge-coupled diode. The imaging lens 203 focuses the light energy from the MEOMS 204 onto the sensing device 202 to read a given packet of memory 201.

The reference beam, split from a beam of the laser (i.e., read beam) by a beam splitter, emanates from the low-power laser (not shown). Typically, the reference beam is less than 5 mW. The laser may be a helium-neon or semiconductor-type laser. The reference beam may be modulated by means of one or more transformation activators (not shown) lying in the optical path of the beam.

A plurality of sequential beams, which contain a plurality of output pages carrying data/information in the memory device, are created by a reference laser beam. Corresponding to each of the beams is a microlens in the array 210, which focuses one of the array of beams 205₁ to 205_{N} onto the addressing device 204 (i.e., one lens per point). In one embodiment, the addressing device 204 is a MEOMS that includes a small mirror (e.g., 2×2 millimeter mirror). Thus, for a matrix with 10 columns and 10 rows, for example, there would be 100 microlenses. The MEOMS 204 focuses the beams through an imaging lens 203 onto a sensing device (e.g., CCD camera) 202. The reading system 200 represents a solid state beam routing system that performs output beam routing without mechanical sensor adjustment.

Retrieving the recorded/stored information from the recording medium 201 requires the use of the reference beam (i.e., read beam) whose characteristics correspond to those employed for writing or for storage. The reference beam induces diffraction due to perturbation in the refractive index corresponding to the characteristics of the beam, thereby creating a data loaded modulated beam.

The reference beam is positioned in order to access a plurality of data packets contained at a defined point (X,Y) on the matrix in the recording medium 201. The reading procedure is similar in the addressing angle values to the writing or recording procedure. However, the reading procedure may be carried out with a greater degree of tolerance than the recording procedure. It is possible to use a very compact laser source of a solid-state type for the reading process because the laser power necessary for reading is much lower than the one for recording.

The plurality of data packets in the recording medium 201 is reconstructed simultaneously by shining the reference beam (i.e., read beam) 208 at the same location in which the data packets were recorded. The reference beam 208 diffracted by the recording medium 201 forms the reconstruction of stored data packet, which is detected by the plurality of arrays of image sensors 202. The reference beam 208 is configured to address the plurality of packets at different locations in the recording medium 201. The plurality of lenses 206₁ to 206_{N} is positioned at different angles to focus the reference beam 208 onto the addressing device 204. The addressing device 204 then addresses the beam to the sensing device 202. The reference beam 208 is shaped and directed by the laser 207 onto the recording medium 201 and from there focused by imaging lenses 206₁ to 206_{N} onto the addressing device 204, and then to the image sensor 202 (e.g., CCD camera), by the imaging lens 203, which has a number of pixels adapted to the desired resolution. The digital output of the image sensor 202 is further processed by a computer (not shown).

The present invention is not to be limited in scope by the specific embodiments described herein. Indeed, this application is intended to cover any modifications of the present invention, in addition to those described herein, and the present invention is not confined to the details which have been set forth. Thus, the scope of the invention should be determined by the appended claims and their legal equivalents, rather than by the examples given.

1. An apparatus comprising:
a recording medium for diffractively recording information designated to a cell;
a laser for transmitting a reference beam to the recording medium; and
an object beam device for transmitting a sequence of object beams to the recording medium at different angles, the object beams intersecting the reference beam at difference angles within the recording medium to form a plurality of patterns.

2. The apparatus according to claim 1 further comprising a display loaded sequentially by information packets for displaying the information to be recorded, the object beams being modulated by reflection off or transmission through the displays.

3. The apparatus according to claim 2 further comprising a lens for focusing the sequentially modulated beam to a point on the recording medium.

4. The apparatus according to claim 1 wherein the recording medium is a polypeptide diffractive holographic memory device.

5. The apparatus according to claim 2 wherein the display is a spatial light modulator (SLM).

6. The apparatus according to claim 1 wherein the cell includes a plurality of interference patterns.

7. The apparatus according to claim 1 wherein the recording medium is made of polypeptide material.

8. An apparatus comprising:
a recording medium for recording information designated to a cell;
a laser for transmitting a reference beam to the recording medium; and
an object beam device for transmitting object beams sequentially to the recording medium at different angles, the object beams simultaneously intersecting the reference beam within the recording medium to form a plurality of patterns.

9. An apparatus comprising:
a recording medium for recording information designated to a cell;
a laser for transmitting a reference beam to the recording medium;
an object beam device for transmitting object beams sequentially to the recording medium at different angles, the object beams intersecting the reference beam within the recording medium to form a plurality of patterns; and
a display for sequentially displaying the information to be recorded, the object beams being modulated by reflection off or transmission through the display.

10. An apparatus comprising:
a recording medium for recording information designated to a cell;
a beam splitter system for transmitting a reference beam to the recording medium;
an object beam device for simultaneously transmitting object beams sequentially to the recording medium at different angles, the object beams intersecting the reference beam within the recording medium to form a plurality of patterns; and
a display for displaying the information to be recorded, the object beams being modulated by reflection off or transmission through the display.

11. A method comprising:
transmitting a reference beam to a recording medium;
sequentially positioning an object beam at different angles;
transmitting the object beam to the medium; and
intersecting the reference beam and the object beam within a cell in the recording medium to form a plurality of patterns.

12. The method according to claim 11 further comprising:
displaying information to be recorded on a display; and
modulating the object beam by reflecting off or transmitting the information through the display.

13. The method according to claim 12 further comprising converging the modulated object beams.

14. The method according to claim 13 wherein the recording medium is a polypeptide layer.

15. The method according to claim 12 wherein the display is a spatial light modulator.

16. The method according to claim 11 wherein the object beams include the plurality of interference patterns.

17. The method according to claim 11 wherein the recording medium is made of polypeptide material.

18. A method comprising:
transmitting a reference beam to a recording medium;
sequentially arranging object beams at different angles;
simultaneously transmitting the object beams to the medium; and
intersecting the reference beam and the object beams within a cell in the recording medium to form a plurality of patterns.

19. A method comprising:
transmitting a reference beam to a recording medium;
sequentially arranging object beams at different angles off a reference beam;
transmitting the object beams to the medium;
intersecting the reference beam and the object beams within a cell in the recording medium to form a plurality of patterns; and
storing information to be read on a sequential display.

20. The method according to claim 19 further comprising modulating the object beams by reflecting off or transmitting the information through the display.

21. The method according to claim 20 further comprising converging the modulated object beams.

22. An apparatus comprising:
a memory device including a cell for containing recorded information;
a beam splitter system for transmitting a reference beam to the memory device to read the recorded information; and
an object beam device for transmitting object beams sequentially to the recording medium at different angles, the object beams intersecting the reference beam within the recording medium to form a plurality of patterns.

23. The apparatus of claim 22 wherein the object beam device is a diffractive optic element.

24. The apparatus of claim 22 wherein the object beam device is a cascade of beam splitters.

25. An apparatus comprising:
a memory device having a plurality of patterns;
a beam system for transmitting a reference beam to the memory device to read the plurality of patterns sequentially;
a plurality of lenses for forming images of the patterns; and
means for converting the images into electrical signals.

26. The apparatus according to claim 23 wherein means of converging is a charge-coupled device (CCD).

27. The apparatus according to claim 24 further comprising a computer for processing and analyzing the electrical signals.
